(19) United States
(12) Patent Application Publication
(10) Pub. No.: US 2006/0107781 A1
(43) Pub. Date: May 25, 2006

(54) Gearshift lever knob for hand shifting vehicle

(76) Inventor: Alice Yao, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/992,819

(22) Filed: Nov. 22, 2004

(51) Int. Cl. G05G 1/04

(52) U.S. Cl. 74/523

(57) ABSTRACT

A gearshift lever knob for hand shifting vehicle includes a knob body having a vertically upward extended and internally threaded mounting hole; an externally threaded sleeve having an upper end screwed into the mounting hole of the knob body, and a lower end downward projected from the knob body to mount on an upper end of a gearshift lever; and a locating cup defining an internally threaded central bore for screwing onto the lower end of the threaded sleeve and thereby tightly pressing the threaded sleeve against the gearshift lever. And, an elastic cover with an anti-slip outer surface encloses an outer surface of the knob body.

### FIELD OF THE INVENTION

The present invention relates to a gearshift lever knob for hand shifting vehicle, and more particularly to a gearshift lever knob that has simple but solid structure allowing easy assembling and disassembling thereof, and is comfortable for gripping.

### BACKGROUND OF THE INVENTION

A gearshift lever knob is designed for mounting on an upper end of a gearshift lever, so that a driver may grip at the knob to manipulate the gearshift lever and change speed. Some car owners who pursue novel and creative things as well as improved vehicle performance would try to change or modify some interior designs and/or related components of their cars, particularly hand shifting cars or remodeled cars that emphasize personal taste or preference. Among other things, the gearshift lever is an item that is often changed to show different thickness according to actual need. It is desirable the original gearshift lever knob could still be mounted on the upper end of the new gearshift lever having a different thickness from the original one.

FIG. 1 shows a conventional gearshift lever knob A, which includes a knob body 1, an inner seat 2, a set of sleeves 3, a fixing screw 4, and a locating ring 5. The inner seat 2 defines a bore 21 therein, and has an upper part fixedly embedded in the knob body 1 and a lower outer wall surface provided with male threads 22. The sleeves 3 included in the same set have the same structure and outer diameter but different inner diameters. The outer diameter of the sleeves 3 corresponds to an inner diameter of the bore 21 of the inner seat 2, so that any one of the sleeves 3 could be fitly mounted in the bore 21. Since the sleeves 3 have different inner diameters, a user may select suitable one from them to match a new or replaced gearshift lever 10 having a specific thickness or outer diameter. The fixing screw 4 is screwed through a screw hole 23 provided on a wall of the inner seat 2 to press against the sleeve 3 mounted in the inner seat 2, so that the sleeve 3 is firmly associated with the inner seat 2. The locating ring 5 is upward screwed to a lower end of the inner seat 2 through engagement of female threads 51 provided in the ring 5 with the male threads 22 provided on the lower outer wall surface of the inner seat 2, and thereby completes the mounting of the gearshift lever knob A to the gearshift lever 10.

The above-described conventional gearshift lever knob A has the following disadvantages:
1. It has complicate structure and could not be easily assembled or disassembled for mounting on the gearshift lever.
2. To enable replacement of a new gearshift lever, the tiny fixing screw 4 and all other components must be disassembled from the knob and therefore possibly results in an undesirably lost fixing screw 4.
3. The locating ring 5 is indirectly associated with the gearshift lever 10 via the inner seat 2 and the sleeve 3. A distance D between outer wall surfaces of the locating ring 5 and the gearshift lever 10 is a sum of wall thickness of the locating ring 5, the sleeve 3, and the inner seat 2, and is considerably large to form an overlarge diameter difference between the locating ring 5 and the gearshift lever 10, which results in a difference between the applied forces at the gearshift lever knob A and the gearshift lever 10 and accordingly adversely affects the manipulation of the gearshift lever 10.
4. The conventional gearshift lever knob A has a hard outer surface that is not comfortable for gripping and tends to skid off the user's hand.

### SUMMARY OF THE INVENTION

It is therefore a primary object of the present invention to provide a simple, solid, comfortable, and easily mountable gearshift lever knob for hand shifting vehicle.

To achieve the above and other objects, the gearshift lever knob of the present invention mainly includes a knob body being provided at a bottom with a vertically upward extended mounting hole, an inner wall surface of which is provided with first female threads; a threaded sleeve having male threads provided on an outer wall surface thereof, and being connected at an upper end to the knob body through engagement of the male threads with the first female threads on the mounting hole of the knob body, and at a downward projected lower end to the upper end of the gearshift lever; and a locating cup defining a vertically extended central bore for receiving the threaded sleeve therein, the central bore having second female threads provided on an inner wall surface thereof, and the locating cup being connected to the downward projected lower end of the threaded sleeve through engagement of the second female threads with the male threads on said threaded sleeve and thereby tightly clamping the threaded sleeve against the gearshift lever.

The gearshift lever knob of the present invention may further include an elastic cover closed over the outer surface of the knob body for a user to comfortably grip there at. The elastic cover is provided on an outer surface with anti-slip structure to enable the user to firmly and stably grip the knob body.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled, partially sectional view of a conventional gearshift lever knob;

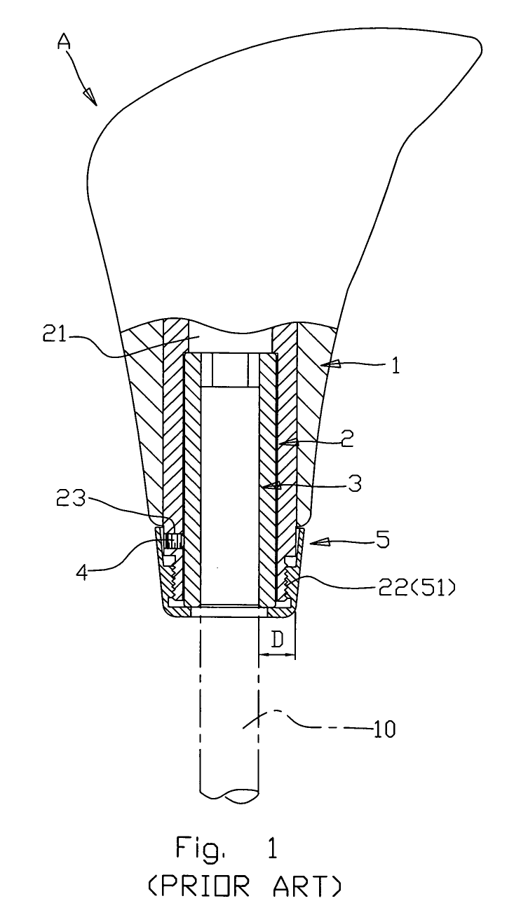

FIG. 2 is an exploded perspective view of a gearshift lever knob for hand shifting vehicle according to the present invention;

FIG. 3 is an assembled, partially sectional view of the gearshift lever knob of FIG. 2; and

FIG. 4 is an assembled perspective view of the gearshift lever knob of FIG. 2.

### DETAILED DESCRIPTION OF THE PREFERRED EMBODIMENTS

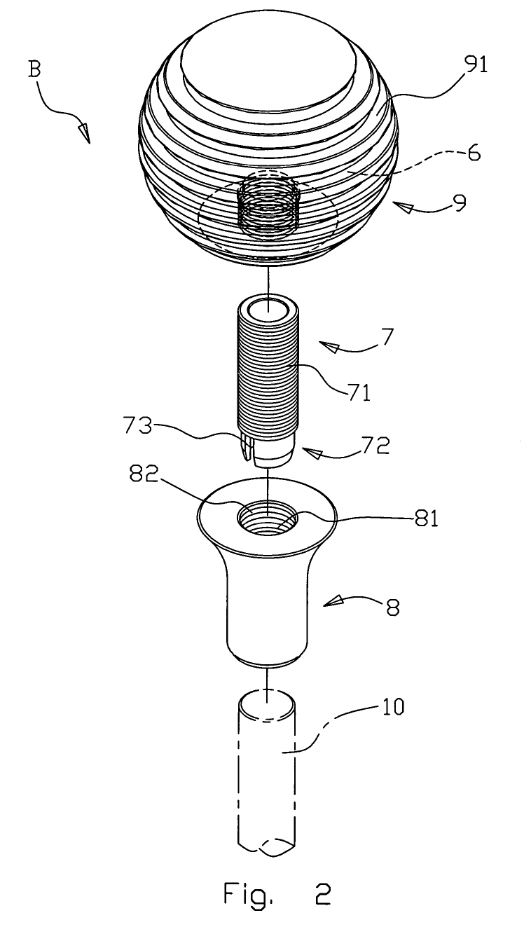

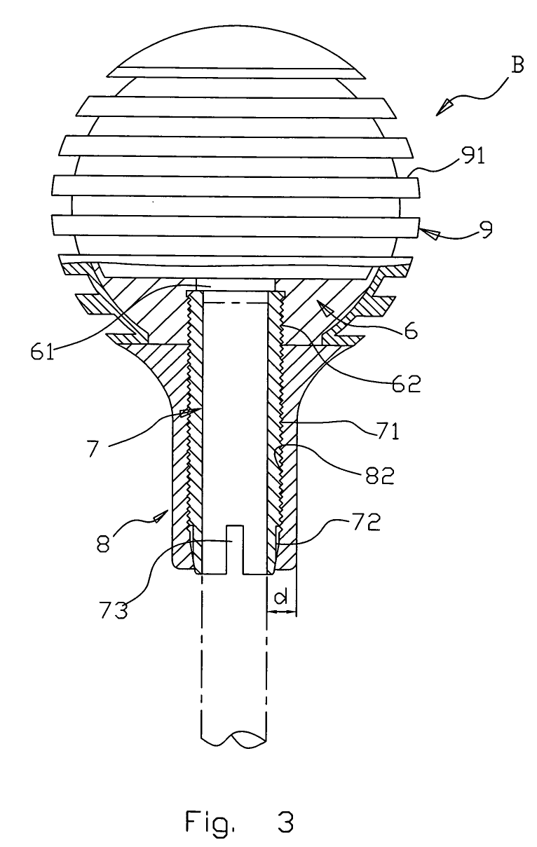

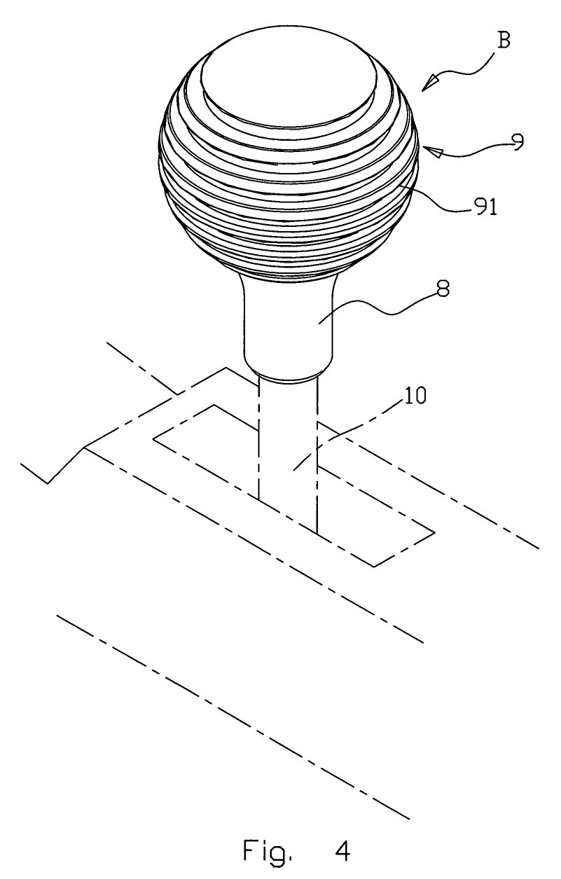

Please refer to FIGS. 2 and 4 that are exploded and assembled perspective views, respectively, of a gearshift lever knob B for hand shifting vehicle according to the present invention, and to FIG. 3 that is an assembled, partially sectional view of the gearshift lever knob B of the present invention.

As shown in these drawings, the gearshift lever knob B for hand shifting vehicle mainly includes a knob body 6, an externally threaded sleeve 7, and a locating cup 8.

The knob body 6 may be of any shape, such as a ball. The knob body 6 is internally provided at a bottom with a vertically upward extended mounting hole 61, an inner wall of which is provided with first female threads 62.

The externally threaded sleeve 7 is provided on an outer wall surface with male threads 71 adapted to mesh with the first female threads 62 in the mounting hole 61 of the knob body 6. The threaded sleeve 7 is connected at an upper end to the knob body 6 through engagement of the male threads 71 with the first female threads 62 of the mounting hole 61, so that a lower end of the threaded sleeve 7 is downward projected from the knob body 6. The lower end of the threaded sleeve 7 is formed into an elastic clamping structure 72 by, for example, providing at least one axial slit 73 on a wall of the lower end of the threaded sleeve 7, allowing the lower end of the threaded sleeve 7 to radially elastically expand when necessary.

In practical application of the present invention, there are multiple pieces of threaded sleeves 7 supplied along with the knob body 6 and the locating cup 8. These threaded sleeves 7 supplied as one set have the same structure and outer diameter but different inner diameters. With these arrangements, a user is allowed to select from the threaded sleeves 7 in the same set a desired one having an inner diameter matching an outer diameter of a gearshift lever 10 in use, so that the selected threaded sleeve 7 could be connected at the upper end to the knob body 6 by engaging the male threads 71 on the sleeve 7 with the first female threads 62 in the knob body 6, and at the lower end to the gearshift lever 10, no matter what thickness the gearshift lever 10 is.

The locating cup 8 is provided with a vertically extended central bore 81, on an inner wall surface of which second females threads 82 are provided. The locating cup 8 is screwed to the threaded sleeve 7 with the second female threads 82 engaged with the male threads 71 at a lower part of the sleeve 7, such that a top of the locating cup 8 is pressed against the bottom of the knob body 6.

To mount the gearshift lever knob B on a new or a replaced gearshift lever 10 having a specific thickness, first select a threaded sleeve 7 having an inner diameter corresponding to the outer diameter of the selected gearshift lever 10. Then, screw the upper end of the threaded sleeve 7 into the mounting hole 61 of the knob body 6. Thereafter, screw the locating cup 8 onto the threaded sleeve 7 to tightly force the elastic clamping structure 72 at the lower end of the threaded sleeve 7 against the gearshift lever 10 and thereby complete the mounting of the gearshift lever knob B of the present invention on the gearshift lever 10.

The gearshift lever knob B of the present invention includes simplified components that could be easily disassembled and assembled for mounting on a new or a replaced gearshift lever 10 with largely reduced time. All the components of the present invention have a volume large enough to eliminate the risk of being carelessly lost. Since the locating cup 8 is indirectly associated with the gearshift lever 10 via the threaded sleeve 7 only, a distance d between outer wall surfaces of the locating cup 8 and the gearshift lever 10 is a sum of the wall thickness of the locating cup 8 and the threaded sleeve 8, which is apparently smaller than the distance D in the conventional gearshift lever knob A. That is, since there is not a significant diameter difference between the gearshift lever 10 and the locating cup 8, an applied force at the gearshift lever knob B is generally consistent with that at the gearshift lever 10 to maintain the gearshift lever 10 in a good operational condition.

The gearshift lever knob B of the present invention may further include an elastic cover 9, such as a rubber cover, for elastically covering an outer surface of the knob body 6 to provide comfortable gripping of the knob body 6 by a user. The elastic cover 9 is provided on outer surface with an anti-slip structure 91, such as a plurality of alternately arranged annular ribs and grooves, to enable firm and stable holding of the knob body 6 by the user.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A gearshift lever knob for mounting on an upper end of a gearshift lever of a hand shifting vehicle, comprising:
a knob body being provided at a bottom with a vertically upward extended mounting hole, an inner wall surface of which is provided with first female threads;
a threaded sleeve having male threads provided on an outer wall surface thereof; said threaded sleeve being connected at an upper end to said knob body through engagement of said male threads with said first female threads on said mounting hole of said knob body, and at a downward projected lower end to the upper end of said gearshift lever; and
a locating cup defining a vertically extended central bore for receiving said threaded sleeve therein, said central bore having second female threads provided on an inner wall surface thereof, and said locating cup being connected to the downward projected lower end of said threaded sleeve through engagement of said second female threads with said male threads on said threaded sleeve and thereby tightly clamping said threaded sleeve against said gearshift lever.

2. The gearshift lever knob for hand shifting vehicle as claimed in claim 1, wherein said locating cup has a top bearing against the bottom of said knob body.

3. The gearshift lever knob for hand shifting vehicle as claimed in claim 1, wherein said threaded sleeve is provided at the lower end with an elastic clamping structure.

4. The gearshift lever knob for hand shifting vehicle as claimed in claim 3, wherein said elastic clamping structure comprises at least one slit axially provided on a wall of the lower end of said threaded sleeve, enabling said lower end of said threaded sleeve to elastically and radially expand when necessary.

5. The gearshift lever knob for hand shifting vehicle as claimed in claim 1, further comprising an elastic cover enclosing an outer surface of said knob body.

6. The gearshift lever knob for hand shifting vehicle as claimed in claim 5, wherein said elastic cover is provided on an outer surface with anti-slip structure.

7. The gearshift lever knob for hand shifting vehicle as claimed in claim 6, wherein said anti-slip structure comprises annular ribs and grooves alternately arranged on the outer surface of said knob body.
